(19) United States
(12) Patent Application Publication
(10) Pub. No.: US 2002/0042832 A1
(43) Pub. Date: Apr. 11, 2002

(54) System and method for interoperability of H.323 video conferences with network address translation

(76) Inventors: Mark D. Fallentine, Hyde Park, UT (US); Mitchell M. Holyoak, North Logen, UT (US); Peter H. Manley, Salt Lake City, UT (US); Forrest K. Blair, Hyde Park, UT (US)

Correspondence Address: TRASK BRITT, P.O. BOX 2550, SALT LAKE CITY, UT, 84110, US

(21) Appl. No.: 09/930,118

(22) Filed: Aug. 14, 2001

Related U.S. Application Data
(60) Provisional application No. 60/225,117, filed on Aug. 14, 2000.

(51) Int. Cl. G06F 15/16; G06F 12/00; G06F 9/26

(52) U.S. Cl. 709/230; 709/246; 711/202

(57) ABSTRACT

The present invention provides a system and methods for allowing any two users each on H.323 compliant systems to conduct calls, specifically video conference calls, in the presence of one or more network address translator (NAT) devices that separates users on an internal private IP network from users on an external public network. The video conference calls according the system and methods of the invention may be performed with Internet directory assistance. Additionally, the video conference calls may be performed through a dual NAT system configuration wherein two users, each on separate private networks, communicate through their respective NAT systems via an external public network.

### CROSS-REFERENCE TO RELATED APPLICATION

This patent application claims benefit of U.S. Provisional Patent Application, Serial No. 60/225,117, filed Aug. 14, 2000, in accordance with 35 U.S.C. §119(e)(1), and the disclosure of which is incorporated herein by reference for all purposes.

### TECHNICAL FIELD

This invention relates to video conferencing over networks using transmission control protocol (TCP)/Internet protocol (IP). More particularly, this invention relates to methods and systems for allowing H.323 compliant systems to simultaneously share the same IP address and/or ports.

### BACKGROUND OF THE INVENTION

Each node in a network has a unique address. Private or self-contained networks may assign arbitrary IP addresses to nodes within the private network. However, in order to properly communicate with nodes on public networks, such as the Internet, software applications must use Internet-legal addresses. For example, if an outgoing message from an application originates from a private network node with an illegal address and sends packets to an Internet-legal IP address on the Internet, the destination will not be able to return packets if the illegal address points to another network on the Internet.

One solution to this problem is to deploy Internet-legal IP addresses across the private network. However, there may be too many systems in the private network, making it difficult or impossible to obtain enough legal IP address blocks to support all of the devices on the private network. Another problem is legacy hardware or application software that uses arbitrarily assigned IP addresses.

A more realistic and common solution is network address translation (NAT) systems. NAT systems, often referred to as IP gateways, may be hardware-based firewalls/routers or software-based protocol converters. In general, NAT systems change the network packets original IP address, port number(s), or both before they arrive at their intended final destination. NAT systems are in common use and also provide added security features for private networks.

H.323 is an umbrella recommendation from the International Telecommunications Union (ITU) that set standards for multimedia communications over Local Area Networks (LANs) that do not provide a guaranteed Quality of Service. Such networks are pervasive on corporate desktops and include packet-switched TCP/IP and IPX over Ethernet, Fast Ethernet and Token Ring network technologies. The H.323 standard, titled: Packet-Based Multimedia Communications Systems, provides a foundation for audio, video, and data communications across IP-based networks, including the Internet. Multimedia products and applications complying with the H.323 standard are interoperable and can communicate with each other and thus are compatible. H.323 may be synonymously referred to herein as a “standard”, a “specification” or a “protocol”. Additionally, there are many “components” that make up the H.323 standard or protocol.

The H.323 specification was approved in 1996 by the ITU's Study Group 16. Version 2 was approved in January 1998. H.323 is broad in scope and encompasses stand-alone devices and embedded personal computer technology, as well as point-to-point and multipoint conferences. H.323 also addresses call control, multimedia management, bandwidth management, and interfaces between LANs and other networks.

The video conferencing industry (i.e., those delivering equipment and/or services for audio and video conferencing over IP networks) faces a major challenge with firewalls and NAT devices. Video conferencing requires multiple channels or connections, using TCP and user datagram protocol (UDP) for its various functions. Firewalls and NAT block and confuse video conferencing endpoints (according to the H.323 standard) impeding successful audio, video, and data conferencing. Some firewall and NAT vendors have taken steps to help alleviate these problems. The leading firewall vendors have modified their products to understand the H.323 protocol and allow video conferencing to work properly without impacting security. This allows video conferencing to work through firewalls, without completely “opening up” the firewall and rendering it completely useless.

However, NAT devices must also understand the H.323 protocol, since the network addresses are negotiated over the H.323 protocol. Historically, NAT devices did not understand H.323, so the negotiated addresses were never changed. This resulted in audio, video, and data never arriving at the other party since the data was always sent to the wrong address. Today, many NAT devices now understand the H.323 protocol, and make the necessary changes to the negotiated addresses so that the data is sent to the correct address.

The problem still exists with the addresses behind the NAT (private addresses, or non-routable addresses). These addresses are ambiguous on the Internet. In other words, these addresses cannot be directly addressed without “statically mapping” or “port forwarding” a public address to the private address. Such addresses are “mapped” correctly when the private side, or inside party, initiates the data, or call. However, data cannot be “mapped” correctly if an outside party initiates the data connection to an inside party. This leads to the problem of outside parties that cannot call “inside parties” behind the NAT. However, “inside parties” have no problem calling “outside parties”.

NAT systems pose a problem for H.323 because H.323 negotiates ports and IP address information in the data payload. Most NAT systems only change the IP address and ports in the IP header, and not in the data payload. H.323 relies on the IP address and ports in the data payload. Furthermore, H.323 components act as a “server” type model, not as a “client” type model. This means that inbound network packets must be able to have a unique destination IP address in order for the packets to arrive at the correct destination. When NAT is deployed, an H.323 client will not be able to receive incoming calls, and audio/video will only work in one direction. NAT systems work very well for client-based models, where unique IP addressing is not important. However, NAT systems have difficulty with most server type models. This is because servers need a public address for clients to access them over the Internet. So, servers are generally placed “outside” of the NAT device.

Placing each client outside of the NAT system to allow H.323 interoperability is infeasible primarily for two reasons. First, placing a client outside the NAT system eliminates the security function provided by the NAT firewall, and thus, may allow hackers easy access to unprotected clients. Second, there may simply be too many clients that would have to be placed outside of the NAT system, i.e., a network architecture limitation.

Another solution to this problem is to “map” an external public IP address to the internal private H.323 client address and use a “NAT smart” H.323 endpoint such as EnVision™ available from Sorenson Vision Inc., Logan, Utah. This solution effectively gives an H.323 client a public IP address on pre-defined ports. However, this solution has shortcomings, e.g., port mapping consumes public IP addresses, only one client may be mapped at a time, and also NAT software limitations.

Yet another solution to this problem is for NAT systems to be H.323 compliant. With this approach the NAT system understands the protocols communicating through it, reads the abstract syntax notation number one (ASN.1) encoding in the data payload (which contains the IP address and port information), makes the correct changes, and writes the payload with new ASN.1 encoding appropriately. However, even under the best case scenario of this approach, incoming call support will not work because of client ambiguity.

Still another approach to solving this problem is called “PhonePatch”, from Equivalence Pty Limited, New South Wales, Australia. The PhonePatch approach provides a “switch-board” accessible by a web browser to alert the private users behind the NAT system to call the outside person back. While this approach is feasible, it has a number of shortcomings, e.g., the inconvenience of using a web browser to tell the other person to call you back, data sharing not being correctly routed, and the limitation of only being able to “ring” a single device behind the NAT system.

For the above reasons, there exists a need in the art for a system and method for allowing H.323 compliant systems to simultaneously share the same IP address and/or ports in networks that employ NAT systems.

### SUMMARY OF THE INVENTION

The present invention provides a system and methods for allowing H.323 compliant systems to simultaneously share the same IP address and/or ports in the presence of NAT systems. At least ten configurations of video conference calls are supported.

A system in accordance with the present invention may include a processor, a storage device in communication with the processor, and computer instructions stored on the storage device and configured for execution by the processor. The computer instructions may perform H.323 synchronization between a first H.323 complaint system located anywhere on an internal private network and a second H.323 compliant system located anywhere on an external public network or on a second private network. The internal private network or said second private network may be separated from the external public network by a NAT system.

Methods according to the present invention may allow the following kinds of calls to be placed between two users: (1) an external EnVision™ placing an Internet locator Service (ILS) call to an internal EnVision™; (2) an external endpoint placing a gateway call to an internal endpoint; (3) an internal endpoint placing an ILS call to an external endpoint; (4) an internal endpoint placing a direct IP call to an external endpoint; (5) an internal endpoint placing a gateway call to an internal endpoint; (6) a non-EnVision™ internal endpoint placing an internal ILS call to a second non-EnVision™ internal endpoint; (7) an internal EnVision™ placing an ILS call to an internal EnVision™; (8) an internal endpoint placing a direct IP or alias call to an internal endpoint; (9) dual NAT, endpoint to endpoint, gateway calling; and (10) dual NAT, EnVision™ to EnVision™, ILS calling.

### BRIEF DESCRIPTION OF DRAWINGS

In the drawings, which illustrate what is currently regarded as the best mode for carrying out the invention and in which like reference numerals refer to like parts in different views or embodiments.

FIG. 1 is a flow diagram illustrating a system and method for an external EnVision™ node making an Internet Locator Service (ILS) call to an internal EnVision™ node in accordance with the present invention.

FIG. 2 is a flow diagram illustrating a system and method for an external endpoint making a gateway call to an internal endpoint in accordance with the present invention.

FIG. 3 is a flow diagram illustrating a system and method for an internal endpoint making an ILS call to an external endpoint in accordance with the present invention.

FIG. 4 is a flow diagram illustrating a system and method for an internal endpoint making a direct IP call to an external endpoint in accordance with the present invention.

FIG. 5 is a flow diagram illustrating a system and method for an internal endpoint making a gateway call to an internal endpoint in accordance with the present invention.

FIG. 6 is a flow diagram illustrating a system and method for an internal endpoint (not an EnVision™ node) making an internal ILS call to an internal endpoint (again not an EnVision™ node) in accordance with the present invention.

FIG. 7 is a flow diagram illustrating a system and method for an internal EnVision™ node making an ILS call to an internal EnVision™ node in accordance with the present invention.

FIG. 8 is a flow diagram illustrating a system and method for an internal endpoint making a direct IP or alias call to an internal endpoint in accordance with the present invention.

FIG. 9 is a flow diagram illustrating a system and method for a dual NAT, endpoint to endpoint gateway call in accordance with the present invention.

FIG. 10 is a flow diagram illustrating a system and method for a dual NAT, EnVision™ node to EnVision™ ILS call in accordance with the present invention.

FIG. 11 is a diagram providing time sequenced data flows for call setup messages for a gateway call from an external endpoint to an internal endpoint in accordance with the present invention.

FIG. 12 is a diagram providing time sequenced data flows for call setup messages for a gateway call from an external EnVision™ node to an internal EnVision™ node in accordance with the present invention.

FIG. 13 is a diagram providing time sequenced data flows for call setup messages for a gatekeeper call from an internal endpoint to an external endpoint in accordance with the present invention.

FIG. 14 is a diagram providing time sequenced data flows for call setup messages for an ILS call from an external EnVision™ node to an internal EnVision™ node in accordance with the present invention.

FIG. 15 is a setup synchronization state diagram in accordance with the present invention.

FIG. 16 is an OLCs synchronization state diagram in accordance with the present invention.

FIG. 17 is a block diagram of a system in accordance with the present invention.

### DETAILED DESCRIPTION OF THE INVENTION

The present invention is a system and method for allowing H.323 compliant systems to simultaneously share the same IP address and/or ports in the presence of NAT systems. In the illustrated embodiments disclosed herein, video conference calling is the application of the invention. However, the disclosed invention is equally applicable to other multimedia applications transmitting or communicating audio, video or data over IP-based networks. The Glasses system is a H.323 gatekeeper and a H.323 gateway that allows incoming calls through a NAT/firewall. The Glasses system is H.323 compliant, meaning that any H.323 compliant endpoint may use Glasses. The invention exploits the H.323 standard by using it in a unique methodology.

The terms “Glasses”, “Glasses system” and “system for H.323 synchronization” are used synonymously herein and refer to the system and methods of the present invention. Additionally, the following definitions are used throughout this disclosure. A “Network Address Translator” (NAT), sometimes referred to as “Network Address Translation” (NAT) is a device or system used to translate a private network address to a public network address and visa versa. An “endpoint” is any H.323 standards compliant computer system including, e.g., EnVision™. An “external endpoint” is an endpoint that resides outside of the domain of the NAT being discussed and may be located on a public or private network. An “internal endpoint” is an endpoint that resides inside the domain of the NAT being discussed and is typically on a private network. The acronym OLC refers to Open Logical Channel in accordance with H.323. Similarly, OLCACK refers to Open Logical Channel Acknowledgement in accordance with H.323. A “private network” refers to a local area network (LAN) or wide area network (WAN) that uses private IP addresses that cannot be routed on a public network, e.g., the Internet.

The Glasses system is a fully routable gatekeeper. Glasses may route all incoming data, all outgoing data, or both, depending on the type of call. The Glasses system complies with the H.323 gatekeeper standard, providing all of the required gatekeeper functions. Glasses may also be defined as a H.323 endpoint proxy.

The Glasses system is also a H.323-to-H.323 gateway. A Gateway call contains the public NAT IP address and an alias of the final call destination. Both of these pieces of information allow the call to be completed. Glasses will accept a gateway type call and route the call to the correct endpoint. This allows for any H.323 endpoint to easily call any internal (behind the NAT) endpoint. Also, Glasses listens on the same ports for audio, video, and data. This provides for firewalls to tighten security by only allowing H.323 to Glasses, but not to multiple other computers.

A significant problem is commonly referred to as “call ambiguity”. Multiple calls could potentially be calling through Glasses to internal endpoints at the same time. Furthermore, these multiple calls could all be coming from the same IP address (from behind another NAT system). This leads to multiple audio packets, video packets, or other data packets all arriving at the same destination (IP address and port), from the same source (IP address and port), and not knowing where they are supposed to go.

Glasses overcomes the call ambiguity problem with call synchronization, when and only when needed. Multiple calls are ambiguous when such calls occur at the same time and emanate from the same source IP address. In these instances, Glasses will only allow one call channel to start at a time. Once Glasses allows each channel to start independent of each conference (endpoint to endpoint multimedia call), it can allow the same connection to start for a different conference. This allows Glasses to send data to the correct endpoints, since it can unambiguously determine where the data should go.

Audio and video data are difficult to synchronize. Glasses must wait for presently transmitting audio/video packets to arrive before it allows another synchronous call to start its audio or video. Glasses uses the SSRC number (a unique number in the packet for each video conference according to H.323) for determining where each audio or video packet goes. Once a call has sent the audio/video initial packets, Glasses will then allow the next conference to proceed with its audio or video, which contain a different SSRC number. Once all the calls are synchronized, multiple packets could be arriving from the same source, and at the same destination. However, by looking at each SSRC, which is unique for each conference, Glasses can unambiguously determine where each packet is supposed to go.

The Glasses system may comprise a software application running on a computer system under an operating system in accordance with the present invention. Computer systems suitable for use with the invention are configured for TCP/IP communication in a networked environment. Suitable operating system environments for the present invention are Windows™ NT Server 4.0, and Windows™ 2000, both available from Microsoft Corporation, Redmond, Wash. Other operating systems suitable for running the application software of the present invention include Windows™ 98, from Microsoft Corporation, various flavors of the Unix operating systems each tailored to specific hardware, such as HP-UX from Hewlett-Packard Company, Solaris, from Sun Microsystems, AIX, from IBM Corporation, IRIX from Silicon Graphics, Inc., and Linux available from a number of vendors running on any personal computer (PC) hardware platform.

Glasses may work behind a NAT device, or work in parallel with a NAT device. If Glasses is configured behind the NAT device, then the NAT device must forward the following incoming ports to Glasses: RAS data TCP port 1719, Q.931 data TCP port 1720, H.245 data TCP port 15329, T.120 data TCP port 1503, EnVision™ Chat data TCP port 15328, and Audio/Video UDP ports 15888-15891. The ports may be configured, for example and not by way of limitation, by editing the Glasses.ini file in a system directory. If Glasses is configured in parallel with the NAT device, then 2 interface cards on the Glasses host is required. No port forwarding is needed when used in parallel. As one of ordinary skill in the art is familiar with such ports, no further explanation of same is detailed herein.

Internet Locator Service (ILS), is a specific form of an Internet “directory assistance” service for obtaining the IP address and/or alias of an endpoint. While “ILS” is the specific example of an Internet directory assistance service used herein, other forms of Internet directory assistance may be used consistent with the present invention. If the user wishes to receive incoming calls when they are registered with an ILS, they will need to use the EnVision™ Network Address Translation address field, and use the public NAT IP address in this field. Once this is done, multiple users behind a NAT will be able to receive incoming calls from any publicly available ILS. If the user wishes to receive non-ILS incoming calls, they must tell the external endpoint to make a gateway call. The gateway address is the NAT public address, and the phone number is the H.323 ID or E.164 address of the internal client they wish to call.

A brief description of the features of Glasses follows. Up to 4096 internal endpoints may be allowed to register or un-register with Glasses. Any endpoint may register with Glasses. Registration makes Glasses aware of the endpoint, what the IP address of the endpoint is, and any alias names the endpoint may be identified by. Glasses enforces that aliases are unique to each endpoint for call identification. Endpoints that register with Glasses are assumed to reside “behind” the NAT device. Glasses may support up to 4096 simultaneous calls within a private network. Calls from one registered endpoint to another registered endpoint are allowed as a direct call. Since Glasses does not do any bandwidth management (only bandwidth control), internal calls are always allowed. Once the call is approved, the endpoints handle and control the rest of the call.

Glasses support at least 10 simultaneous calls between internal endpoints and external (e.g., Internet) endpoints. Calls from an internal endpoint to any external endpoint must be routed through Glasses. A call may be defined as audio and/or video transmitted in both directions. It does not matter who initiates the call. Because of the limitations of the NAT device, all of the incoming audio and video data has an ambiguous endpoint destination. Each piece of data, or packet, must then be analyzed to carefully determine the correct destination endpoint. Resolution of call ambiguity occurs in realtime, and can potentially put a significant load on the Glasses host computer. As additional simultaneous calls are added, the quality of service for each conference is reduced (e.g., additional latency).

Glasses supports T.120 data, for 10 simultaneous conferences, for calls between internal endpoints and external endpoints. T.120 data (whiteboard, file transfer, chat, and application sharing) is provided in both directions, in addition to audio and video. Glasses also supports routing of EnVision™ chat data, for 10 simultaneous conferences, between internal endpointsand external endpoints. EnVision™ Chat is provided in both directions.

Glasses may be configured for running on Windows® NT Server 4.0 as a service. More specifically, Glasses may be configured to run on Windows® NT Server 4.0 or Windows® 2000 as a service. User settings (such as the external NAT IP address) may be configured in an initialization file. Glasses complies with the H.323 gatekeeper standard. The H.323 standard has specific minimum requirements for a gatekeeper. All of these minimum requirements may be included in Glasses, e.g., bandwidth control, endpoint registration, admissions. Additionally, Glasses supports system logging. Error and warning messages only may be reported to the system event log.

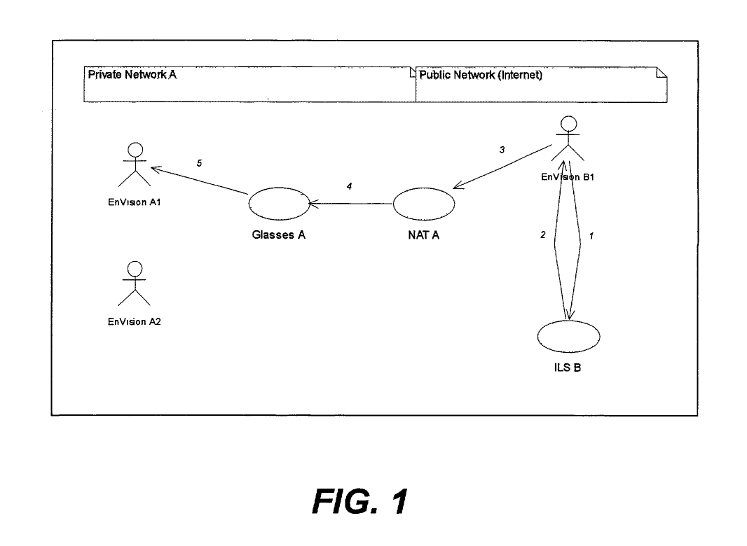

FIG. 1 is a flow diagram illustrating a system and method for an external EnVision™ node B1 making an Internet Locator Service (ILS) ILS B call to an internal EnVision™ node A1 in accordance with the present invention. A method for placing an ILS call from an external EnVision™ node to an internal EnVision™ node may include: (1) external EnVision™ B1 querying ILS B for a list of the users registered with it; (2) ILS B returning a list of the registered users including the IP address and H323-ID (e-mail address) for each registered user; (3) EnVision™ B1 using the information returned from ILS B for initiating a call to NAT A's IP address including the H323-ID of EnVision™ A1; (4) NAT A forwarding the message to Glasses A; (5) Glasses A using the H323-ID in the message for looking up the registered endpoint and then forwarding the message to EnVision™ A1; (6) EnVision™ A1 performing an admissions request from Glasses A, then approving the request as a gatekeeper routed call; and (7) the call proceeding through Glasses A.

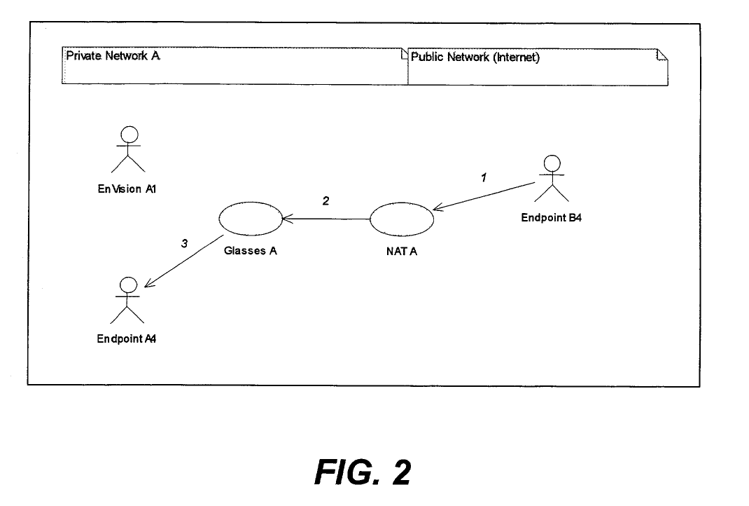

FIG. 2 is a flow diagram illustrating a system and method for an external endpoint making a gateway call to an internal endpoint in accordance with the present invention. A method for placing a gateway call from an external endpoint to an internal endpoint may include: (1) external endpoint B4 initiating a gateway call to NAT A's IP address and endpoint A4's E.164-ID (telephone number); (2) NAT A forwarding the message to Glasses A; (3) Glasses finding the E.164-ID in the message, looking up the registered endpoint, and then forwarding the message to endpoint A4; (4) endpoint A4 performing an admissions request from Glasses A, then Glasses approving of the request as a gatekeeper routed call; and (5) the call proceeding through Glasses A.

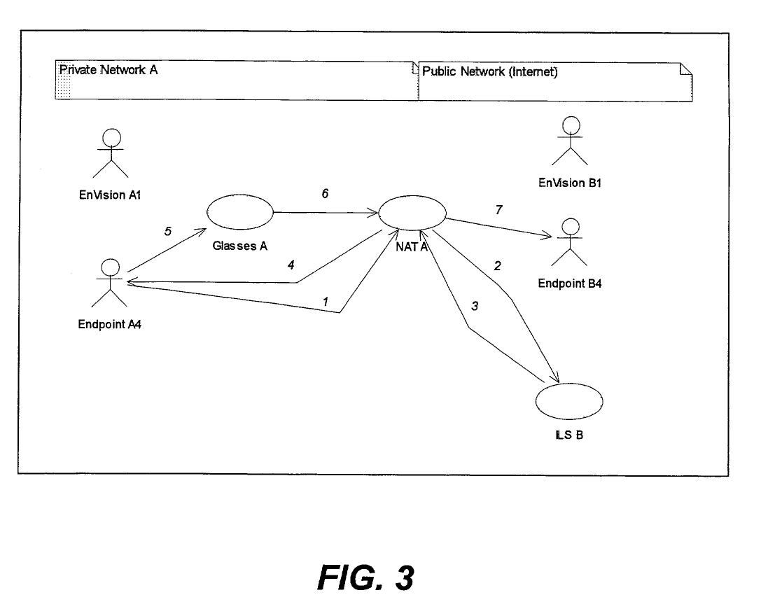

FIG. 3 is a flow diagram illustrating a system and method for an internal endpoint making an ILS call to an external endpoint in accordance with the present invention. A method for placing an ILS call from an internal endpoint to an external endpoint may include: (1) internal endpoint A4 querying ILS B for a list of the users registered with it and NAT A intercepting the message and changing the IP header so that the messages are routed through NAT A; (2) NAT A forwarding the query to ILS B; (3) ILS B returning a list of the registered users including the IP addresses for each registered user; (4) NAT A forwarding the registered users to endpoint A4; (5) endpoint A4 using the information returned from the ILS and asking Glasses A for permission to make a call to endpoint B4; (6) Glasses A recognizing that endpoint B4 is external to the NAT A and telling endpoint A4 to make a Glasses routed call to endpoint A4; (7) endpoint A4 then initiating the call through Glasses A; (8) Glasses A forwarding the message to endpoint B4, NAT A intercepting the message, changing the IP header and forwarding the message to endpoint B4; and (9) the call proceeding through Glasses A.

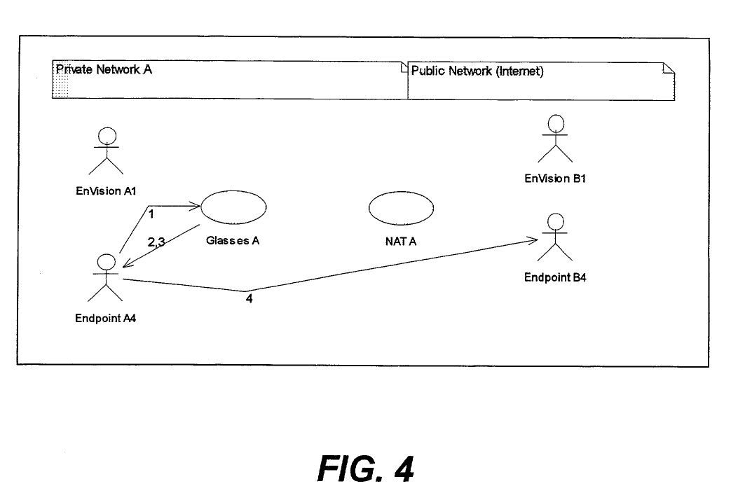

FIG. 4 is a flow diagram illustrating a system and method for an internal endpoint making a direct IP call to an external endpoint in accordance with the present invention. A method for placing a direct IP call from an internal endpoint to an external endpoint may include: (1) internal endpoint A4 requesting permission from Glasses A to call endpoint B4 directly by IP address; (2) Glasses A giving permission to endpoint A4 to place the call; (3) endpoint A4 performing an admissions request from Glasses A, and then Glasses A approving the request as a gatekeeper routed call; and (4) the call proceeding through Glasses A.

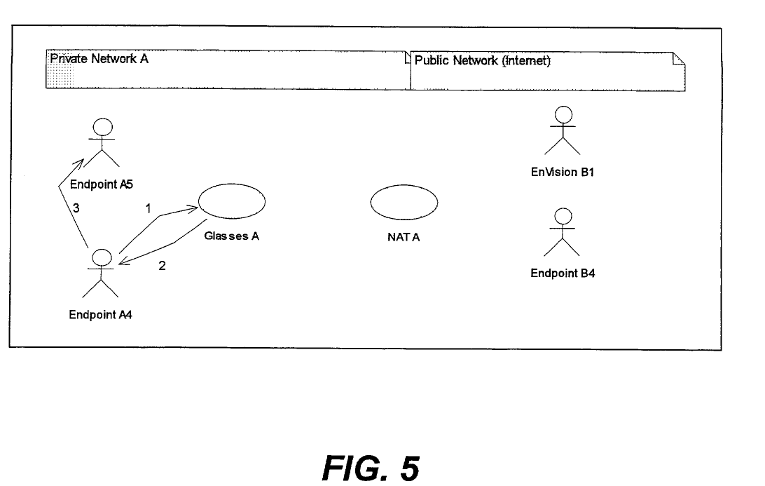

FIG. 5 is a flow diagram illustrating a system and method for a first internal endpoint making a gateway call to a second internal endpoint in accordance with the present invention. A method for placing a gateway call from a first internal endpoint to a second internal endpoint may include: (1) endpoint A4 requesting from Glasses A permission to make a gateway call to endpoint A5; (2) Glasses A checking if the alias and IP requested are a registered match, and if there is a registered match, then approving the call as a direct call, if the IP address requested is a registered endpoint, but the alias does not match, then rejecting the call and if the alias requested is a registered endpoint, but the IP address does not match, then approving the call as a routed call through Glasses A to endpoint A5; and (3) the call proceeding directly between endpoint A4 and endpoint A5.

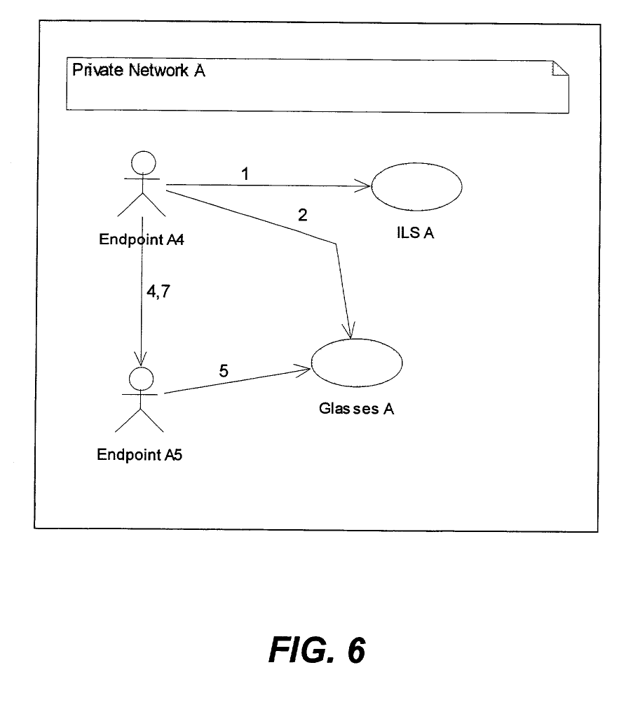

FIG. 6 is a flow diagram illustrating a system and method for a first internal endpoint (not an EnVision™ node) making an internal ILS call to a second internal endpoint (again not an EnVision™ node) in accordance with the present invention. A method for placing an internal ILS call from a first internal endpoint that is not an EnVision™ node to a second internal endpoint that is also not an EnVision™ node may include: (1) internal endpoint A4 looking up the address for endpoint A5 from ILS A; (2) endpoint A4 requesting from Glasses A permission to make a call to the IP address of endpoint A5; (3) Glasses A recognizing that endpoint A5 is a registered, internal endpoint and approving a direct call; (4) endpoint A4 calling endpoint A5; (5) endpoint A5 requesting permission to accept the call from Glasses A; (6) Glasses A approving the call between endpoint A4 and endpoint A5; and (7) the call proceeding between endpoint A4 and endpoint A5.

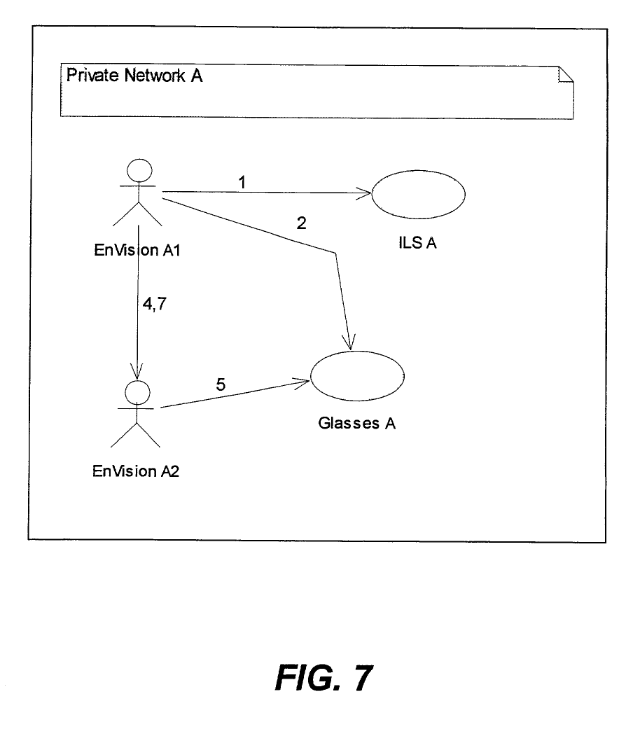

FIG. 7 is a flow diagram illustrating a system and method for a first internal EnVision™ node making an ILS call to a second internal EnVision™ node in accordance with the present invention. A method for placing an ILS call from a first internal EnVision™ node to a second internal EnVision™ node may include: (1) internal EnVision™ A1 looking up the address for EnVision™ A2 using ILS A; (2) EnVision™ A1 requesting permission from Glasses A to place a call to the IP address of EnVision™ A2; (3) Glasses A recognizing that EnVision™ A2 is a registered, internal EnVision™ node and that the IP address for EnVision™ A1 and EnVision™ A2 on ILS A are the same, approving the request, and sending the correct (private) IP address of EnVision™ A2 back to EnVision™ A1; (4) EnVision™ A1 calling EnVision™ A2 using the correct (private) IP address; (5) EnVision™ A2 requesting permission to accept the call from Glasses A; (6) Glasses A approveing the call between EnVision™ A1 and EnVision™ A2; and (7) the call proceeding between EnVision™ A1 and EnVision™ A2.

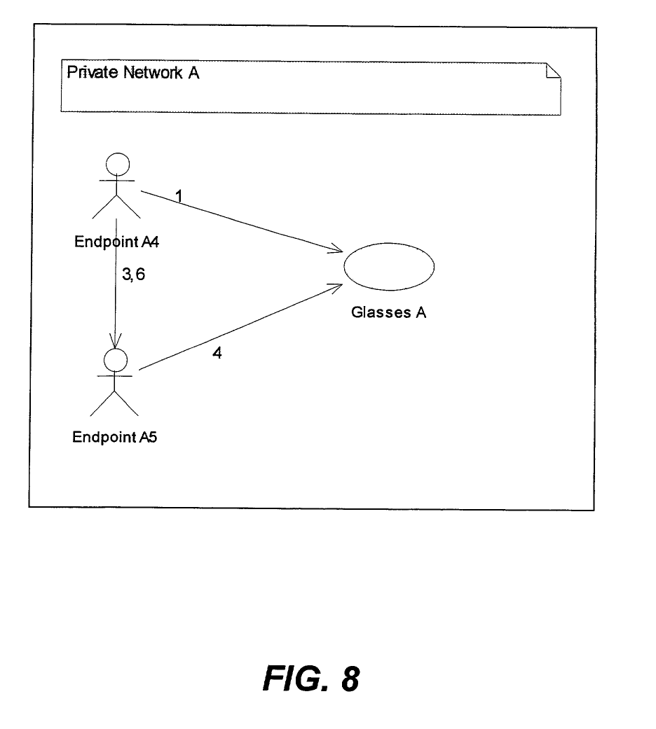

FIG. 8 is a flow diagram illustrating a system and method for a first internal endpoint making a direct IP or alias call to a second internal endpoint in accordance with the present invention. A method for placing a direct IP or alias call from a first internal endpoint to a second internal endpoint may include: (1) endpoint A4 requesting from Glasses A permission to place an IP or alias call to endpoint A5; (2) Glasses A looking up the IP address for endpoint A5, and approving the request; (3) endpoint A4 calling endpoint A5; (4) endpoint A5 requesting call acceptance approval from Glasses A; (5) Glasses A approving the call between endpoint A4 and endpoint A5; and (6) the call proceeding between endpoint A4 and endpoint A5.

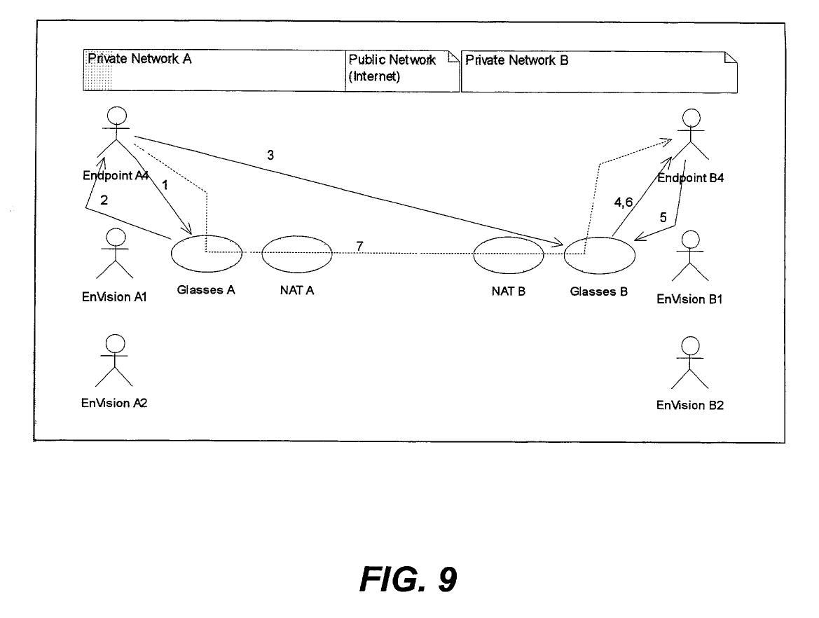

FIG. 9 is a flow diagram illustrating a system and method for a dual NAT, endpoint-to-endpoint, gateway call in accordance with the present invention. A method for placing a dual NAT, endpoint-to-endpoint, gateway call may include: (1) endpoint A4 calling endpoint B4 as a gateway call, endpoint A4 using the IP address of NAT B and the alias of endpoint B4, endpoint A4 performing an admissions request with Glasses A; (2) Glasses A determining that the IP address of NAT B is not registered with Glasses A, and approving the call as a gatekeeper routed call; (3) endpoint A4 calling endpoint B4 through Glasses A and, unknown to A4, through Glasses B; (4) Glasses B seeing an incoming gateway call for endpoint B4 and Glasses B continuing the call to endpoint B4; (5) endpoint B4 seeing a call from Glasses B, and then performing an admissions request to Glasses B for a call between endpoint B4 and Glasses B (which is really endpoint A4); (6) Glasses B approving the admissions request; and (7) Glasses B continuing the call from what appears to be from NAT A, but which is really endpoint A4, to endpoint B4. Calls will appear to come from NAT A or NAT B. Because multiple calls may be routed between the same IP addresses, incoming connections and audio/video data will have ambiguous final destinations. This ambiguity is solved by synchronization on each OLC which contains the type of channel, the source IP address, and the source port.

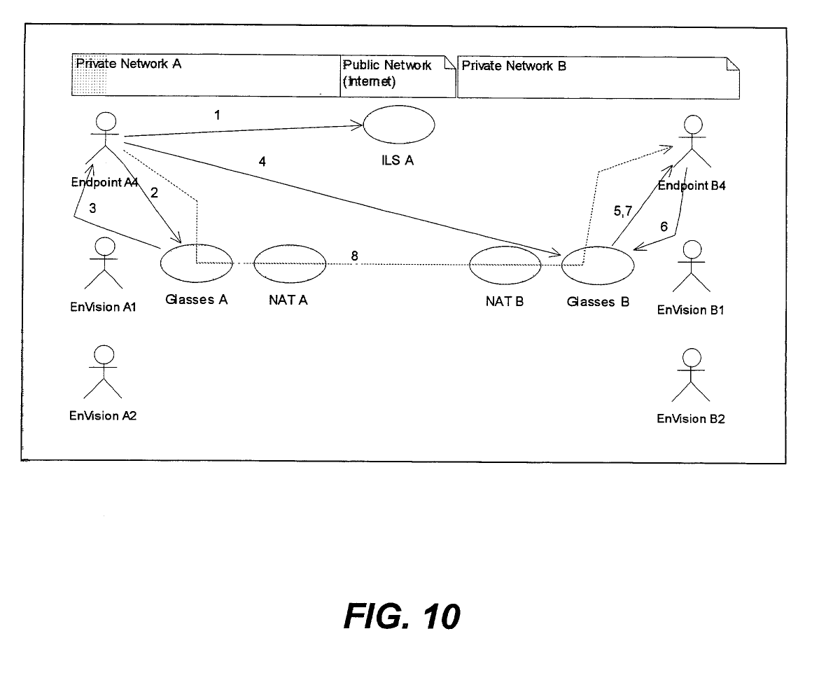

FIG. 10 is a flow diagram illustrating a system and method for a dual NAT, EnVision™ node-to-EnVision™ node ILS call in accordance with the present invention. A method for placing a dual NAT, EnVision™ node-to-EnVision™ node ILS call may include: (1) endpoint A4 querying ILS A, a public network ILS, for the alias and IP address of endpoint B4; (2) endpoint A4 calling endpoint B4 as a gateway call and endpoint A4 using the IP address of NAT B and the alias of endpoint B4, then endpoint A4 performing an admissions request with Glasses A; (3) Glasses A determining that the IP address of NAT B is not registered, and approving the call as a gatekeeper routed call; (4) endpoint A4 calling endpoint B4 through Glasses A and, unknown to A4, through Glasses B; (5) Glasses B seeing an incoming gateway call for endpoint B4 and Glasses B continuing the call to endpoint B4; (6) endpoint B4 seeing a call from Glasses B and then performing an admissions request to Glasses B for a call between endpoint B4 and Glasses B, but which is really endpoint A4; (7) Glasses B approving the admissions request; and (8) Glasses B continuing the call from what appears to be from NAT A, but which is really Endpoint A4, to endpoint B4.

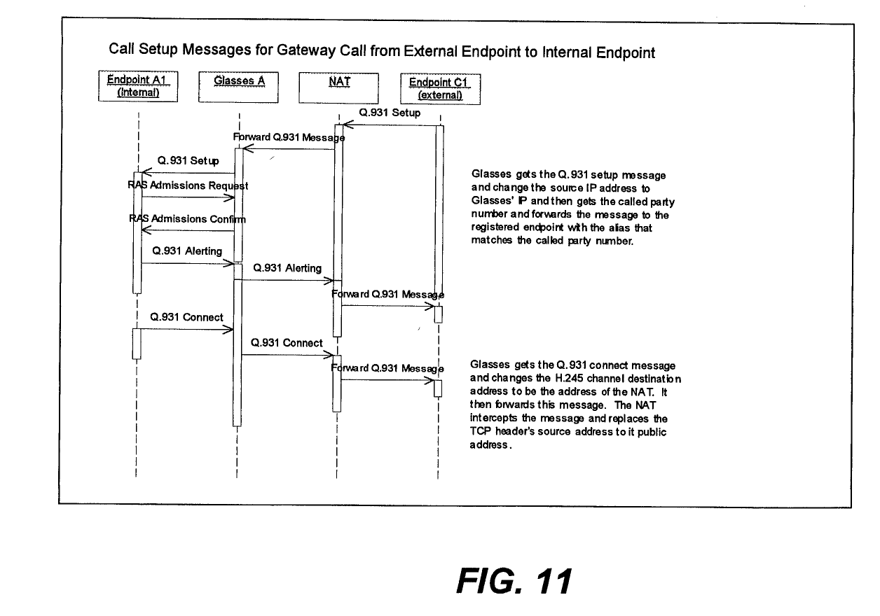

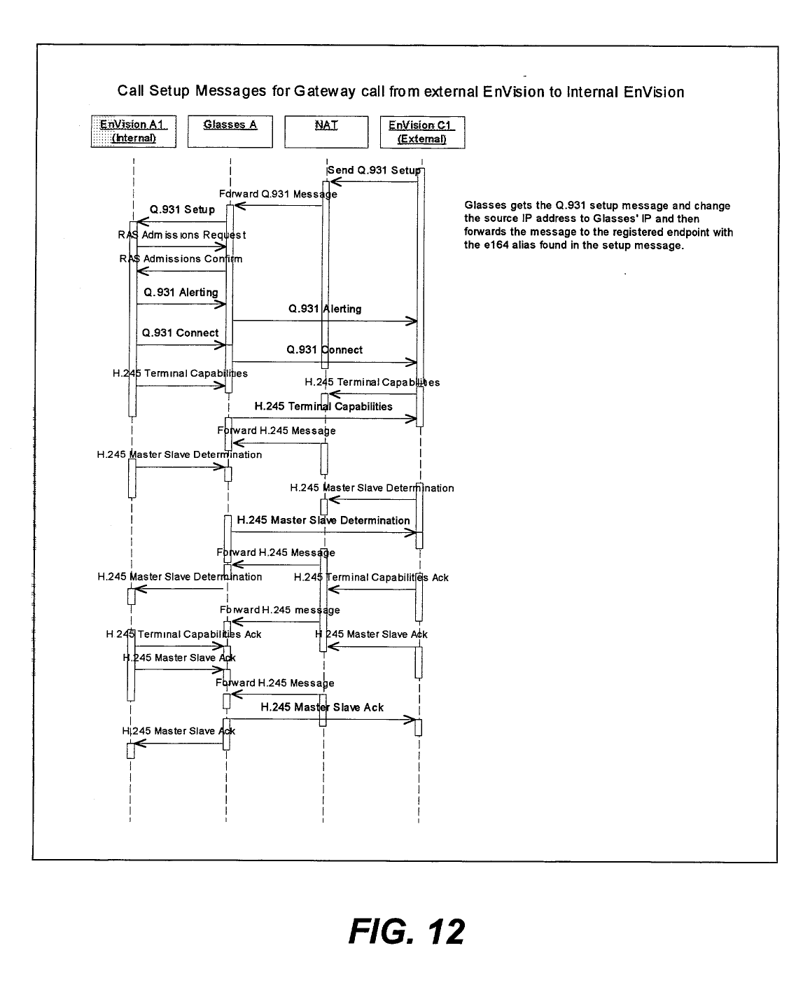

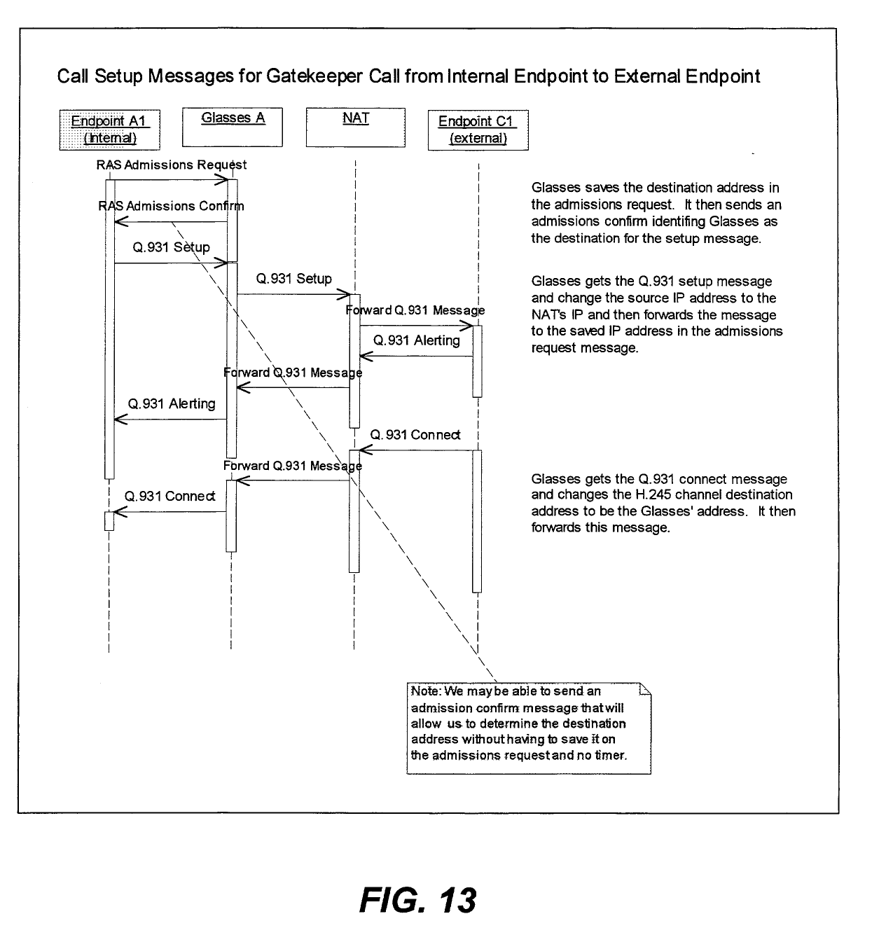

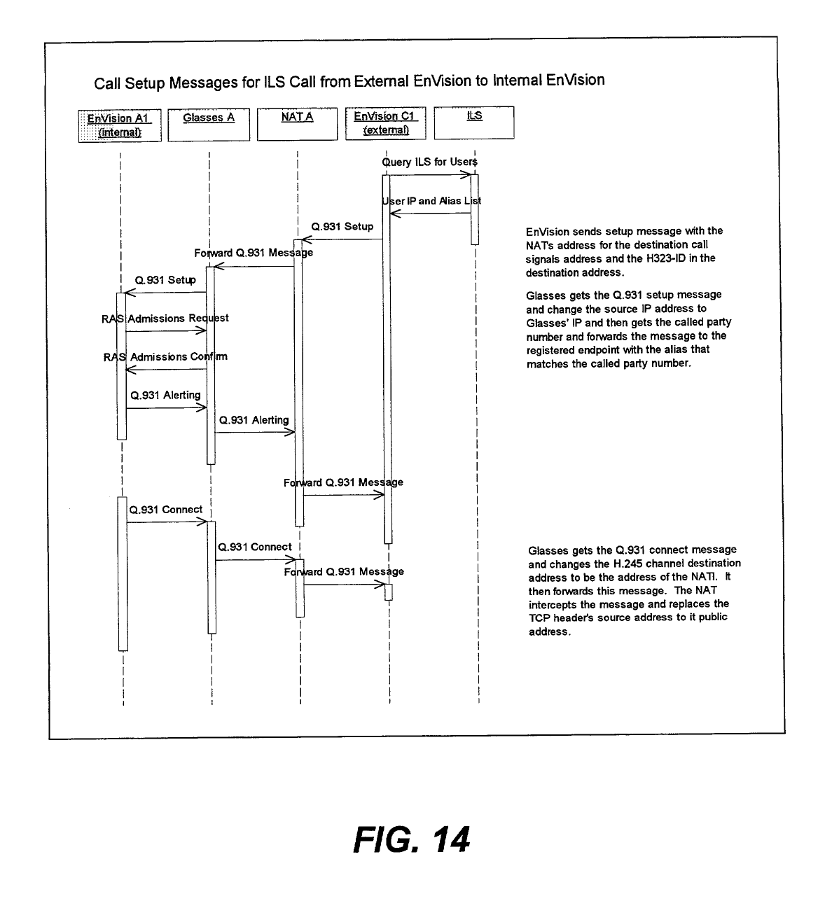

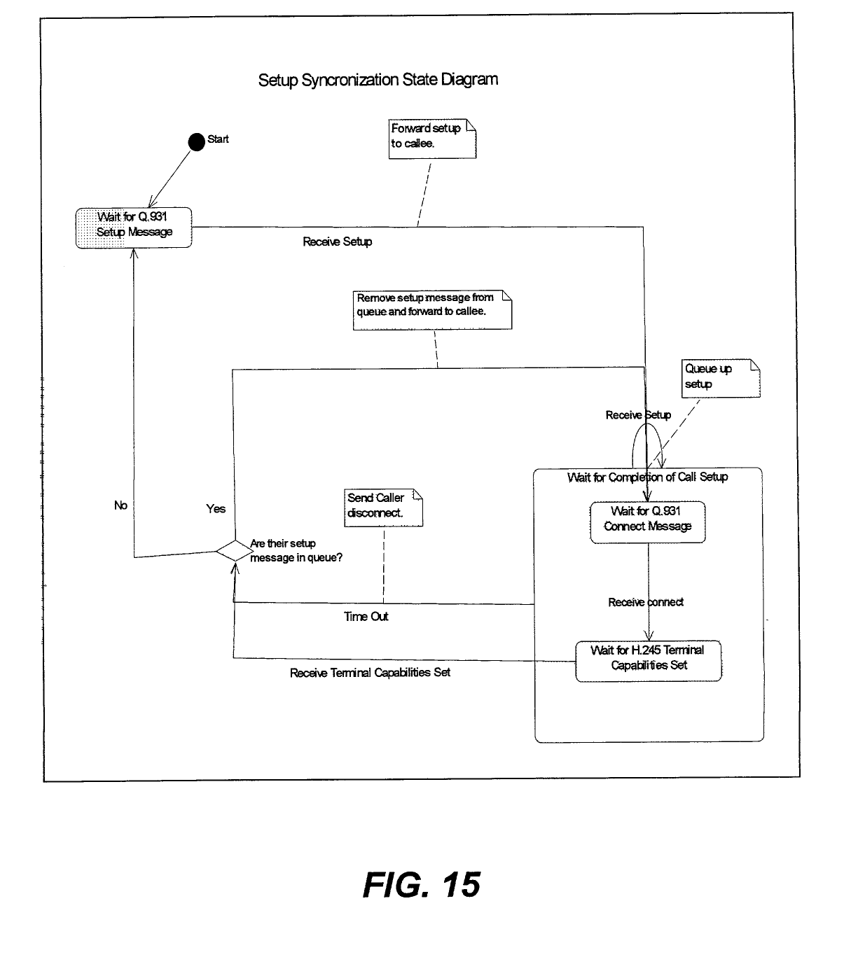

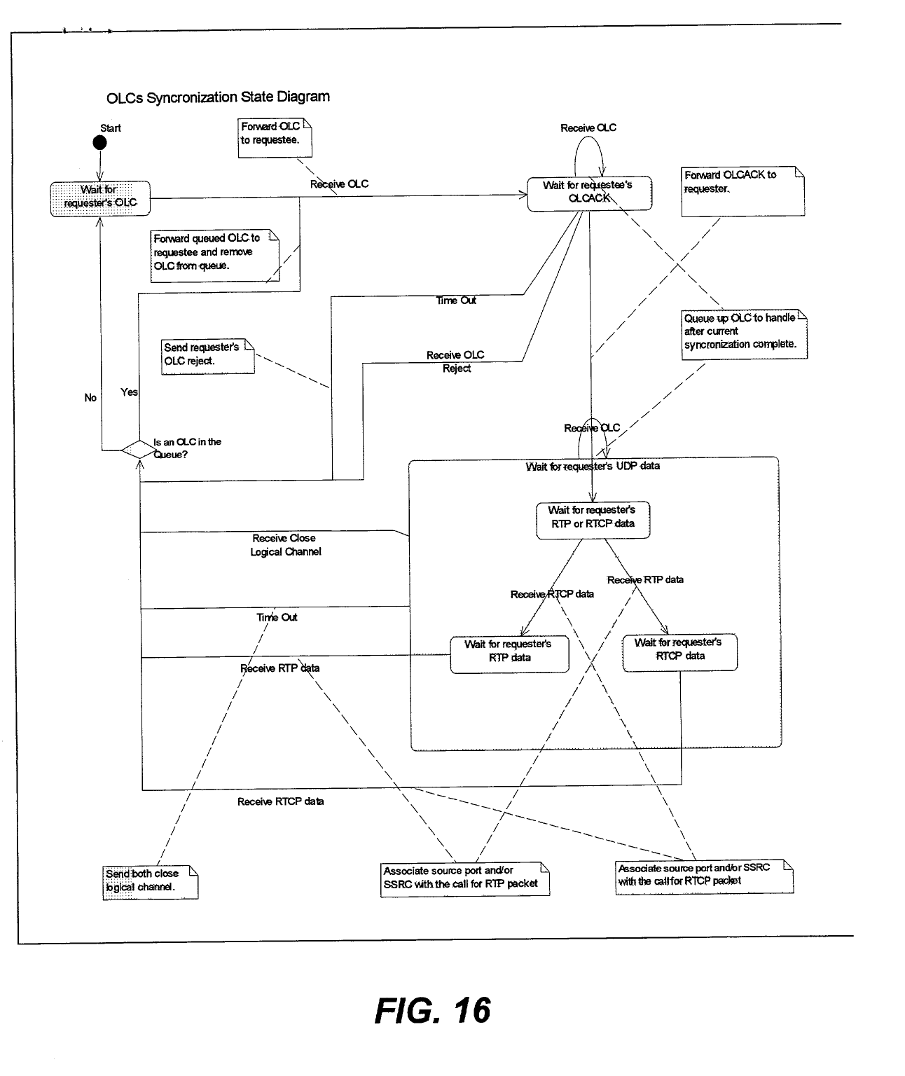

FIG. 11 is a diagram providing time sequenced data flows for call setup messages for a gateway call from an external endpoint to an internal endpoint in accordance with the present invention. FIG. 12 is a diagram providing time sequenced data flows for call setup messages for a gateway call from an external EnVision™ node to an internal EnVision™ node in accordance with the present invention. FIG. 13 is a diagram providing time sequenced data flows for call setup messages for a gatekeeper call from an internal endpoint to an external endpoint in accordance with the present invention. FIG. 14 is a diagram providing time sequenced data flows for call setup messages for an ILS call from an external EnVision™ node to an internal EnVision™ node in accordance with the present invention. FIG. 15 is a setup synchronization state diagram in accordance with the present invention. FIG. 16 is an OLCs synchronization state diagram in accordance with the present invention.

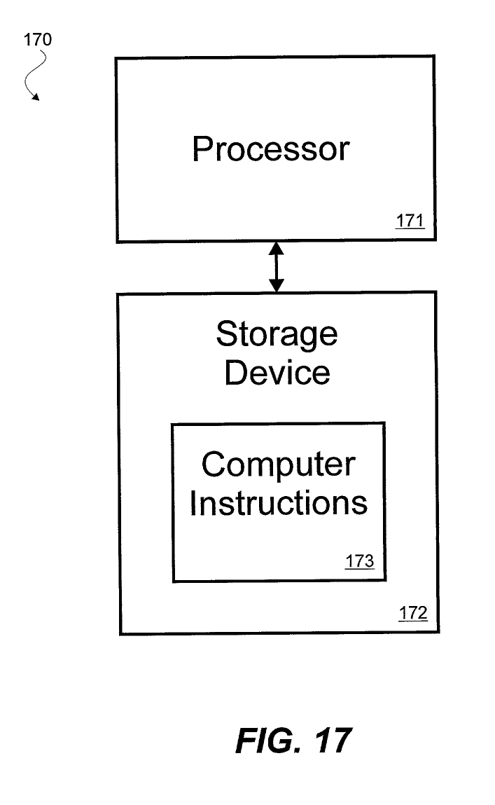

FIG. 17 is a block diagram of a system 170 for interoperability of H.323 video conferences with NAT in accordance with the present invention. System 170 may include a processor 171 and a storage device 172. Storage device 173 may have computer instructions 173 stored within it. The computer instructions 173 implement the methods according to the present invention described herein.

Although this invention has been described with reference to particular embodiments, the invention is not limited to these described embodiments. Rather, it should be understood that the embodiments described herein are merely exemplary and that a person skilled in the art may make many variations and modifications without departing from the spirit and scope of the invention. All such variations and modifications are intended to be included within the scope of the invention as defined in the appended claims.

What is claimed is:

1. A system for use with network address translation (NAT) systems, comprising:
a processor; and
a storage device in communication with said processor; and
computer instructions stored on said storage device and configured for execution by said processor, wherein said computer instructions perform H.323 synchronization between a first H.323 compliant system located anywhere on an internal private network and a second H.323 compliant system located anywhere on an external public network or on a second private network, wherein said internal private network or said second private network are separated from said external public network by a NAT system.

2. The system of claim 1, wherein said first H.323 compliant system shares the same IP address and/or ports with said second H.323 compliant system.

3. The system of claim 1, further comprising an H.323 compliant gatekeeper.

4. The system of claim 1, further comprising an H.323 compliant gateway.

5. The system of claim 1, further comprising an H.323-to-H.323 gateway.

6. The system of claim 1, further comprising an H.323 endpoint proxy.

7. A method for placing a video conference call using an Internet Locator Service (ILS) from a first H.323 compliant node on a public network to a second H.323 compliant node on a private network, said public network separated from said private network by a Network Address Translation (NAT) device, said method comprising:
providing a system for H.323 synchronization located on said private network and in communication with said NAT device and said second H.323 compliant node;
querying an ILS for an IP address corresponding to said NAT and email address of said second H.323 compliant system;
initiating said video teleconference call through said NAT at said IP address;
synchronizing said video teleconference call through said system for H.323 synchronization to said second H.323 compliant node at said email address; and
performing said video teleconference call as an H.323 gatekeeper routed call.

8. A method for placing a video conference call from an external H.323 endpoint located on a public network to an internal H.323 endpoint on a private network, said public network separated from said private network by a Network Address Translation (NAT) device, said method comprising:
providing a system for H.323 synchronization located on said private network and in communication with said NAT device and said internal H.323 endpoint;
initiating said video conference call to said NAT;
synchronizing said video conference call through said system for H.323 synchronization to said internal H.323 endpoint; and
performing said video teleconference call as an H.323 gatekeeper routed call.

9. A method for placing a video conference call using an Internet Locator Service (ILS) from an internal endpoint on a private network to an external endpoint on a public network, said public network separated from said private network by a Network Address Translation (NAT) device, said method comprising:
providing a system for H.323 synchronization located on said private network and in communication with said NAT device and said internal endpoint;
querying said ILS for contact information about said external endpoint via said NAT device;
asking permission from said system for H.323 synchronization to contact said external endpoint based on said contact information;
initiating said video conference call through said system for H.323 synchronization to said external endpoint upon approval; and
performing said video teleconference call through said system for H.323 synchronization.

10. A method for placing a direct IP video conference call from an internal endpoint on a private network to an external endpoint on a public network, said public network separated from said private network by a Network Address Translation (NAT) device, said method comprising:
providing a system for H.323 synchronization located on said private network and in communication with said NAT device and said internal endpoint;
requesting permission from said system for H.323 synchronization to call said external endpoint directly by IP address;
receiving permission and synchronizing said video teleconference call through said system for H.323 synchronization to said external endpoint; and
performing said video teleconference call as a gatekeeper routed call directly between said internal endpoint and said external endpoint.

11. A method for placing a gateway video conference call from a first internal endpoint to a second internal endpoint, said method comprising:
providing a system for H.323 synchronization in communication with said first internal endpoint and said second internal endpoint;
requesting permission from said system for H.323 synchronization to make a gateway call from said first internal endpoint to said second internal endpoint having an alias and an IP address;
checking to see if said alias and said IP address is a registered match;
if said alias and said IP address are registered, then said gateway video conference call is approved as a direct call between said first internal endpoint and said second internal endpoint;
if said IP address is registered endpoint but said alias is not registered, then said gateway video conference call is rejected; and
if said alias is registered but said IP address is not registered, then said gateway video call is approved as a routed call through said system for H.323 synchronization to said second internal endpoint.

12. A method for placing an Internet Locator Service (ILS) call from a first internal endpoint to a second internal endpoint, said method comprising:
providing a system for H.323 synchronization in communication with said first internal endpoint and said second internal endpoint;
querying said ILS for contact information about said second internal endpoint;
requesting permission from said system for H.323 synchronization to direct call said second internal endpoint;
recognizing and approving said direct call to said second internal endpoint; and
proceeding with said direct call between said first internal endpoint and said second internal endpoint.

13. A method for placing an Internet Locator Service (ILS) call from a first internal EnVision™ node to a second internal EnVision™ node, said method comprising:
providing a system for H.323 synchronization in communication with said first EnVision™ node and said second EnVision™ node;
querying said ILS for contact information for said second internal EnVision™ node;
requesting permission from said system for H.323 synchronization to make a call to said second internal EnVision™ node based on said contact information;
recognizing said second internal EnVision™ node is registered and approving said call;
sending said first internal EnVision™ node a private IP address corresponding to said second internal EnVision™ node;
said first internal EnVision™ node calling said second internal EnVision™ node at said private IP address;
said second internal EnVision™ node requesting permission from said system for H.323 synchronization to accept said call; and
proceeding with said call between said first internal EnVision™ node and said second internal EnVision™ node after receiving permission from said system for H.323 synchronization.

14. A method for placing a direct IP address or alias call from a first internal endpoint to a second internal endpoint, said method comprising:
providing a system for H.323 synchronization in communication with said first internal endpoint and said second internal endpoint;
said first internal endpoint requesting permission from said system for H.323 synchronization to place said direct IP address or said alias call from said first internal endpoint to said second internal endpoint;
approving said request to place said direct IP address or said alias call;
said first internal endpoint calling said second internal endpoint;
said second internal endpoint requesting permission to accept said call; and
proceeding with said direct IP address or alias call between said first internal endpoint and said second internal endpoint.

15. A method for placing a dual network address translation (NAT) device, endpoint to endpoint, gateway call from a first endpoint located on a first private network to a second endpoint located on a second private network, said first private network being separated from a public network by a first NAT device and said second private network being separated from said public network by a second NAT device, said method comprising:
providing a first system for H.323 synchronization in communication with said first endpoint and said second endpoint and a second system for H.323 synchronization in communication with said second endpoint;
said first endpoint gateway calling said second endpoint using an IP address of said second NAT device and an alias of said second endpoint;
said first endpoint performing an admissions request with said IP address to said first system for H.323 synchronization;
said first system for H.323 synchronization determining that said IP address is not registered with said first system for H.323 synchronization and approving said admissions request as a gatekeeper routed call;
said first endpoint placing said call to said second endpoint through said first system for H.323 synchronization, said first NAT device, said second NAT device and said second system for H.323 synchronization in turn;
said second endpoint performing an admissions request to said second system for H.323 synchronization; and
performing said call between said first endpoint and said second endpoint after receiving approval from said admissions request.

16. A method for placing a dual network address translation (NAT) device, EnVision™ node to EnVision™ node, Internet Locator Service (ILS) assisted call, said method comprising:
providing a first system for H.323 synchronization in communication with said first endpoint and said second endpoint and a second system for H.323 synchronization in communication with said second endpoint;
said first endpoint querying said ILS for contact information including an IP address for said second NAT device and alias for said second endpoint;
said first endpoint gateway calling said second endpoint using said IP address for said second NAT device and said alias of said second endpoint;
said first endpoint performing an admissions request with said IP address to said first system for H.323 synchronization;
said first system for H.323 synchronization determining that said IP address is not registered with said first system for H.323 synchronization and approving said admissions request as a gatekeeper routed call;
said first endpoint placing said call to said second endpoint through said first system for H.323 synchronization, said first NAT device, said second NAT device and said second system for H.323 synchronization in turn;
said second endpoint performing an admissions request to said second system for H.323 synchronization; and
performing said call between said first endpoint and said second endpoint after receiving approval from said admissions request.
